(19) United States
(12) Patent Application Publication
(10) Pub. No.: US 2014/0354618 A1
(43) Pub. Date: Dec. 4, 2014

(54) DISPLAY DEVICE AND PROTECTING METHOD OF THE SAME

(71) Applicant: Samsung Display Co., Ltd., Yongin-City (KR)

(72) Inventor: Byung-Hyuk SHIN, Yongin-City (KR)

(73) Assignee: Samsung Display Co., Ltd., Yongin-City (KR)

(21) Appl. No.: 14/066,326

(22) Filed: Oct. 29, 2013

(30) Foreign Application Priority Data
May 30, 2013 (KR) 10-2013-0062053

(51) Int. Cl. H02H 7/20; H02H 3/08

(52) U.S. Cl. CPC H02H 7/20; H02H 3/08
USPC 345/212

(57) ABSTRACT

A display device and a protection method thereof are provided. A display device includes a display panel including a plurality of pixels configured to display an image according to an image data signal and a film package including at least one driving circuit. The film package includes a base film integrated with the driving circuit and a bonding pad connecting each of the driving circuits between the display panel and the base film, and the driving circuit includes a current sensor detecting the amount of current corresponding to a driving power source from at least one wire of a plurality of supply wires of driving power voltages, the supply wires passing through the film package in the display panel.

### CROSS-REFERENCE TO RELATED APPLICATION

This application claims priority to and the benefit of Korean Patent Application No. 10-2013-0062053 filed in the Korean Intellectual Property Office on May 30, 2013, the entire contents of which are incorporated herein by reference.

### BACKGROUND

(a) Field

A display device and a protection method thereof are provided. Particularly, a method for protecting a display device from a failure of a display panel due to an excessive current, and a display device using the same are provided.

(b) Description of the Related Art

A display device includes a display panel displaying an image and a driving circuit for driving the display panel.

Driving power voltages (ELVDD and ELVSS) are supplied to the display device for powering a light source or for driving the display panel. In supplying the driving power voltage, a failure may occur in the display panel due to a local concentration of current or to cracks. When such a failure occurs, an excessive current is generated, and smoke or fire may occur in the panel, resulting in a burn.

Additionally, designs for printed circuit boards (PCBs) for display devices are limited, and therefore a simple design that can overcome the limitations in conventional designs for PCBs, and a current monitoring system that can prevent failure due to coupling or distortion of signals are needed.

The above information disclosed in this Background section is only for enhancement of understanding of the background of the disclosure and therefore it may contain information that does not form the prior art that is already known to a person of ordinary skill in the relevant art.

### SUMMARY

A display device is provided that can prevent an occurrence of a failure in a display panel by monitoring the amount of current in supplying of a driving voltage.

In addition, when a power voltage is supplied in the display device, local concentration may cause an overcurrent in the display panel. Therefore, a design system is provided that can detect the overcurrent in real time and protect the system of the entire display device if a burn occurs.

A display device includes a display panel including a plurality of pixels, the plurality of pixels configured to display an image based on an image data signal and a film package including at least one of driving circuits, and the film package includes a base film integrated with the at least one driving circuit and a bonding pad connecting each of the driving circuits between the display panel and the base film.

The at least one driving circuit includes a current sensor detecting the amount of current corresponding to a driving power source from at least one wire of a plurality of supply wires of driving power voltages, the supply wires passing through the film package in the display panel.

The driving power voltage may include a predetermined high-level first power source voltage and a predetermined low-level or ground-potential second power source voltage.

The current sensor may include: at least one measuring unit configured to measure an amount of current and connected to an input unit and an output unit of the driving power voltage to measure the amount of current corresponding to the driving power voltage; at least one amplification unit and a resistor controlling the amount of current measured by the measuring unit; a first output terminal outputting information on the controlled amount of current; a second output terminal converting the information on the controlled amount of current and outputting as a digital information value; and a third output terminal comparing the controlled amount of current with a predetermined reference voltage and outputting a fault signal when the controlled amount of current is excessive compared to the amount of current of the reference voltage.

The measuring unit may be a current sensor using a Hall effect or a current sensor using resistance in a path through which the driving power voltage is transmitted, but the present invention is not limited thereto.

The display device may further include a monitoring unit monitoring information on the amount of current output from the first output terminal or the second output terminal.

The display device may further include a signal controller receiving the current amount information output from the first output terminal or the second output terminal, and generating and transmitting a control signal that turns off a power system or a driving system of the display device when the amount of current exceeds a predetermined current amount.

The signal controller may receive the image data signal, acquire information on an expected amount of current corresponding to luminance of the image data signal, and transmit the information on the expected amount of current to the current sensor of the driving circuit, and the current sensor may compare a measured current amount with the expected current amount.

The display device may further include a logic unit acquiring information on a comparison result output from the third output terminal and performing an operation, and the logic unit outputs an enable signal that controls operation of a driving system of the display device corresponding to a fault signal generated based on the comparison result.

A method for protecting a display device is provided, the display device including a plurality of pixels configured to display an image based on an image data signal, at least one driving circuit, and a film package including the at least one driving circuit. The method for protecting the display device includes: detecting the amount of current corresponding to a driving power voltage passing through the film package in the display panel from at least one of a plurality of supply wires; controlling the detected amount of current and outputting the controlled amount of current as at least one of analog information, digital information, and a fault signal, where the fault signal is set by comparing the controlled amount of current with a predetermined reference voltage, and outputting the fault signal corresponding to a comparison result when the detected amount of current is excessive compared to an amount of current corresponding to the predetermined reference voltage; and monitoring the analog information or digital output information and turning off a power system or driving system of the display device when the amount of current is excessive compared to a predetermined current amount or when the fault signal is transmitted.

The display device may further include a signal controller, and the method may further include receiving the analog information or digital information, comparing the received information with a predetermined current amount, and generating a control signal that turns off the power system or driving system of the display device when the amount of current exceeds the predetermined current amount.

The display device may further include a signal controller, and the signal controller may acquire information on an expected amount of current corresponding to luminance of the image data signal by receiving the input data signal and transmits information on the expected amount of current to the driving circuit.

The display device may further include a logic unit acquiring information on the comparison result and performing an operation, and the logic unit may output an enable signal that controls operation of the driving system of the display device corresponding to the fault signal generated according to the comparison result.

In supply of a predetermined power voltage to a display device, the amount of current at each location of the display panel can be monitored in real time, and the system of the entire display device is turned off when an overcurrent is generated to thereby prevent generation of heat due to the overcurrent or occurrence of firing in advance.

In addition, a histogram of each location extracted from input data for the amount of current detected is compared with the amount of current so that abnormal concentration of current can be determined, thereby improving product yield of a high-quality display device.

The display device and the protection method thereof according to the can be formed by using a PCB design structure so that the PCB structure can be simple and module design competitiveness can be assured.

### BRIEF DESCRIPTION OF THE DRAWINGS

FIG. 1 illustrates a portion of a configuration for a display device in which a panel protection method is applied.

FIG. 2 is an enlarged view of the portion “A” of FIG. 1.

FIG. 3 schematically shows a configuration of a driving circuit 30 of FIG. 1.

FIG. 4 is a schematic circuit diagram of a configuration of a current sensing unit in the driving circuit of FIG. 3.

FIG. 5 shows a partial configuration of the display device where a burn occurred and a graph of monitored voltages.

FIG. 6 is a circuit diagram of an external logic unit performing current sensing and monitoring for burn protection.

FIG. 7 shows a method for protecting the display device using a digital output value output from the current sensing unit of FIG. 4.

FIG. 8 shows a display device protection method of a signal controller using the digital output value of FIG. 7.

FIG. 9 schematically shows a structure of the display device where a current concentration phenomenon occurs in a normal condition.

FIG. 10 schematically shows a current sensing method using a root resistor of a chip on film (COF).

### DETAILED DESCRIPTION OF THE EMBODIMENTS

The present disclosure will be described more fully hereinafter with reference to the accompanying drawings, in which example embodiments are shown. As those skilled in the art would realize, the described embodiments may be modified in various different ways, all without departing from the spirit or scope of the present disclosure.

Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

When a burn occurs in a display panel, the entire panel system is turned off to protect the display device. However, unless the display device includes a system that can monitor, in real time, the supply of current based on the power voltage supplied to the panel, and includes a system for sensing damage due to an excessive current, failure of the display panel cannot be prevented, and product reliability and quality competitiveness may be deteriorated.

Display devices have recently increased in size while also having high resolution. A system for monitoring, in real time, the power voltage supplied to such large-sized display panels, and for preventing a burn from occurring as the result of an excessive current is needed, to thereby assure price competitiveness and module competitiveness.

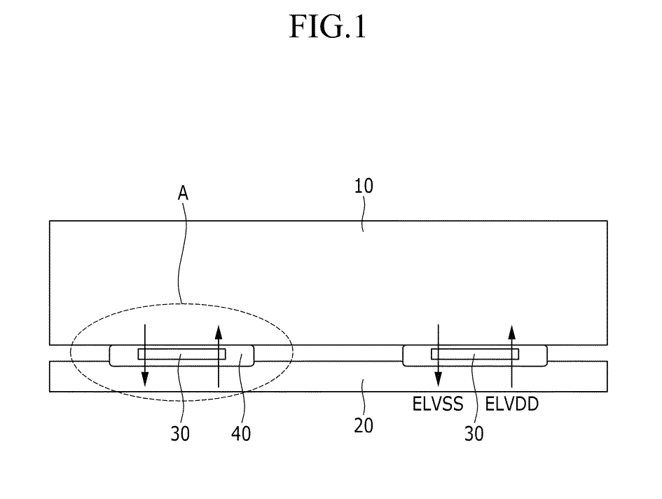

Is FIG. 1 shows a portion of a configuration for display device having a panel protection method applied thereto.

Referring to FIG. 1, a display device includes a display panel 10 including a plurality of pixels that display an image, a driving circuit 30 transmitting a data voltage according to a predetermined image data signal to each pixel of the display panel 10, a base film 20 having the driving circuit 30 mounted thereon, and a bonding pad 40 connecting the driving circuit 30 to the display panel 10.

The driving circuit 30 is mounted on the base film 20 through the bonding pad 40 using a chip on film (COF) method and thus electrically connected with the display panel 10. However, the present disclosure is not limited thereto, and the driving circuit 30 may be directly mounted on the display panel 10 using a chip on glass method.

The driving circuit 30 may include a gate driver transmitting gate signals that respectively activate the plurality of pixels through gate lines connected to the plurality of pixels, a data driver transmitting a voltage that depends on the data signal through data lines respectively connected to the plurality of pixels, and a signal controller controlling driving timing of the gate driver and the data driver. A power supply that supplies a power source voltage to the display panel and constituent elements of the driving circuit 30 may be provided as necessary.

The driving circuit 30 of FIG. 1 may include the gate driver, the data driver, the signal controller, and the power supply, may include at least one of a group consisting of the gate driver, the data driver, the signal controller, and the power supply.

Referring to FIG. 1, the driving circuit 30 is a plurality of driving circuits, and forms a driver integrated circuit. That is, as a data driver and a gate driver, a plurality of driving circuits connected to a plurality of gate line units or connected to a plurality of data line units may be provided on the base film 20.

In FIG. 1, a plurality of driving circuits 30 are formed on the base film 20 as a data source driver transmitting a data signal.

A power supply wire transmitting a driving power source voltage is provided, and passes through the driving circuit 30 and the bonding pad 40 of FIG. 1. That is, as shown in FIG. 1, in the display device according to an example embodiment, a plurality of power supply wires transmit a first power source voltage ELVDD (indicated with an arrow) and a second power source voltage ELVSS (indicated with an arrow) as driving power source voltages through the driving circuit 30 and the bonding pad 40 in which the driving circuit 30 is installed.

In further detail, a plurality of first power supply wires are provided. The first power supply wires connected to first electrodes of the driving transistors of the respective pixels, and supply a predetermined high-potential first power source voltage ELVDD to the respective pixels.

In addition, a plurality of second power source wires are provided. The second power source wires are connected to cathodes of organic light emitting diodes of the respective pixels, and supply a predetermined ground voltage or a low-potential second power source voltage ELVSS to the organic light emitting diodes.

The first power source voltage ELVDD and the second power source voltage ELVSS may be applied to the driving circuit 30 through the bonding pad 40 on the base film 20 through a part of the plurality of first and second power supply wires.

As another example embodiment, as a power supply wire unit corresponding to one driving circuit 30, all the plurality of first power supply wires and the plurality of second power supply wires may pass through the bonding pad 40.

As another example embodiment, as a power supply wire unit corresponding to one driving circuit 30, a portion of the plurality of first and second power supply wires may pass through the driving circuit 30, and other wires may pass through the bonding pad 40.

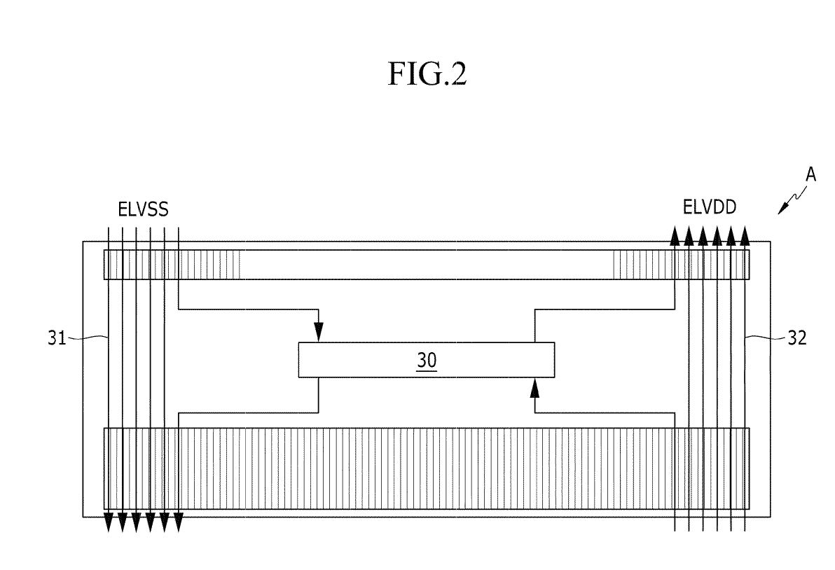

FIG. 2 is an enlarged view of the portion “A” of FIG. 1. That is, FIG. 2 shows an enlarged view of one driving circuit 30 in the driving IC and power supply wires passing therethrough.

Referring to FIG. 2, six of first power supply wires 32 transmitting the first power source voltage ELVDD and six of second power supply wires 31 transmitting the second power source voltage ELVSS are provided.

One of the first power supply wires 32 and one of the second power supply wires 31 are directly connected to the driving circuit 30.

The driving circuit 30 may detect the amount of current corresponding to the first power source voltage ELVDD and the second power source voltage ELVSS respectively transmitted through the first power supply wire 32 and the second power supply wire 31 that are directly connected to the driving circuit 30.

In FIG. 2, the output direction of the six of the first power supply wires 32 and the six of the second power supply wires is not limited to one direction as shown in the drawing. The power source voltage may be input or output in both directions.

As another example, the six of the first power supply wires 32 and the six of the second power supply wires 31 of FIG. 2 may be provided at a distance from the driving circuit 30 rather than being directly connected to the driving circuit 30.

In such an embodiment, a unit for detecting the amount of current in the driving circuit 30 (a sensing unit) detects the amount of current by using an additional wire that is electrically connected with one of the separated power supply wires. Alternatively a sensing unit may be provided on the exterior of the driving circuit 30 and then electrically connected to the power supply wire.

That is, a structure in which a sensing unit that detects the amount of current is provided in the driving circuit 30 and an interface configuration type connected to the sensing unit for transmitting the amount of current is not limited to any particular structure.

In a conventional circuit structure for detecting the first power source voltage ELVDD and the second power source voltage ELVSS, a current sensor is provided in each input portion of each of the power voltage supply wires, so that a circuit structure is complicated and a lot of parts are required, thereby causing an increase of the PCB area.

Further, an alarm signal is generated with reference to an output voltage of the current sensor, and a signal of a TTL level should be transmitted through several PCBs and connectors, and therefore a failure may occur due to coupling or distortion between the signals.

Thus, in the driving circuit having such a structure of the implementation of FIG. 1 and FIG. 2, the amount of current of each of the first power source voltage ELVDD and the second power source voltage ELVSS is detected and measured, so that the above-stated problem of the conventional circuit structure can be solved.

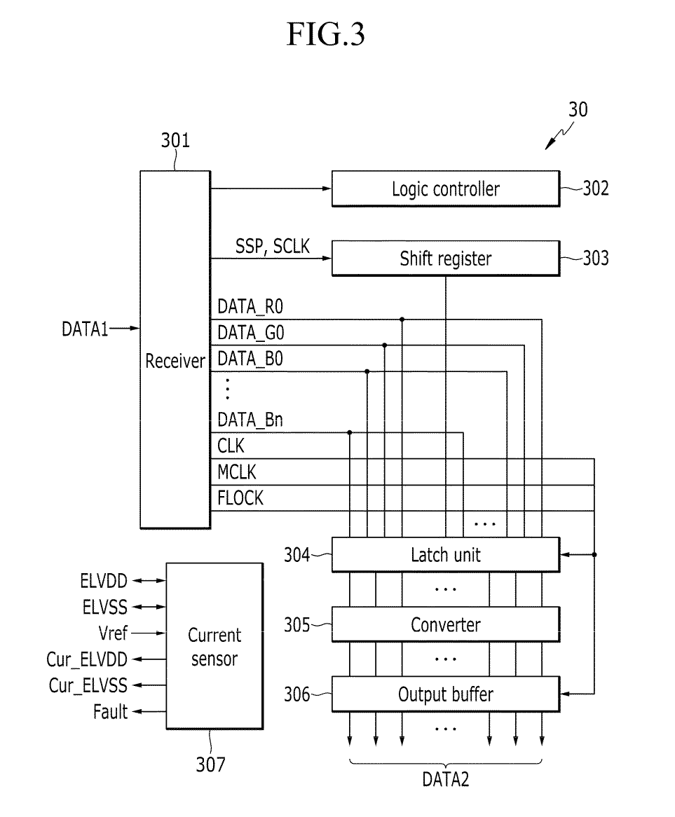

FIG. 3 schematically shows a configuration of driving circuit 30 of FIG. 1.

FIG. 3 illustrates an example of a data driver source outputting a data voltage according to a data signal, and the present disclosure is not limited thereto.

Referring to FIG. 3, the driving circuit 30 includes a receiver 301 receiving an external image signal DAT1, a logic controller 302 performing a logic control on the driving circuit, a shift register 303 outputting a sampling signal by shifting the same according to an input start pulse SSP and an input clock signal SCLK transmitted from the receiver 301, a latch unit 304 latching and outputting input pixel data DATA_R0, DATA_G0, and DATA_B0 through DATA_Bn of the external image signal in response to the sampling signal, a converter 305 converting the input pixel data DATA_R0, DATA_G0, and DATA_B0 through DATA_Bn to analog pixel data voltages using input gamma voltages, and an output buffer 306 buffering and outputting the analog pixel data voltages from the converter 304.

Output pixel data DATA2 corresponding to each of the plurality of pixels is transmitted to each of the plurality of pixels of the display panel through each of a plurality of output channels controlled by the driving control signals respectively corresponding to the plurality of pixels from the output buffer unit 306.

The driving circuit 30 may further include a multiplexer based on an output channel of a data line.

The configuration of the driving circuit FIG. 3 is not limited to the example embodiment of FIG. 3, and a gate driver, a signal controller, and a power source may be further provided.

The driving circuit 30 of FIG. 3 further includes a current sensor 307.

The current sensor 307 includes a plurality of constituents that can perform all functions of a conventional driving circuit, and at the same time the current sensor 307 can detect the amount of current in a power supply wire path for supplying the first power source voltage ELVDD and the second power source voltage ELVSS.

The current sensor 307 may receive the first power source voltage ELVDD through a plurality of first power source voltage supply wires through which the first power source voltage ELVDD is input or output.

In addition, the current sensor 307 may receive the second power source voltage ELVSS through a plurality of second power source voltage supply wires through which the second power source voltage ELVSS is input or output.

The current sensor 307 may receive a reference voltage Vref for detecting the amount of current, and may generate and transmit a signal Cur_ELVSS with respect to the amount of current of the first power source voltage and a signal CUR_ELVSS with respect to the amount of current of the second power source voltage.

When an excessive amount of current flows compared to the reference voltage Vref, a fault signal may be generated to alert the system of a danger, and to turn off the system power.

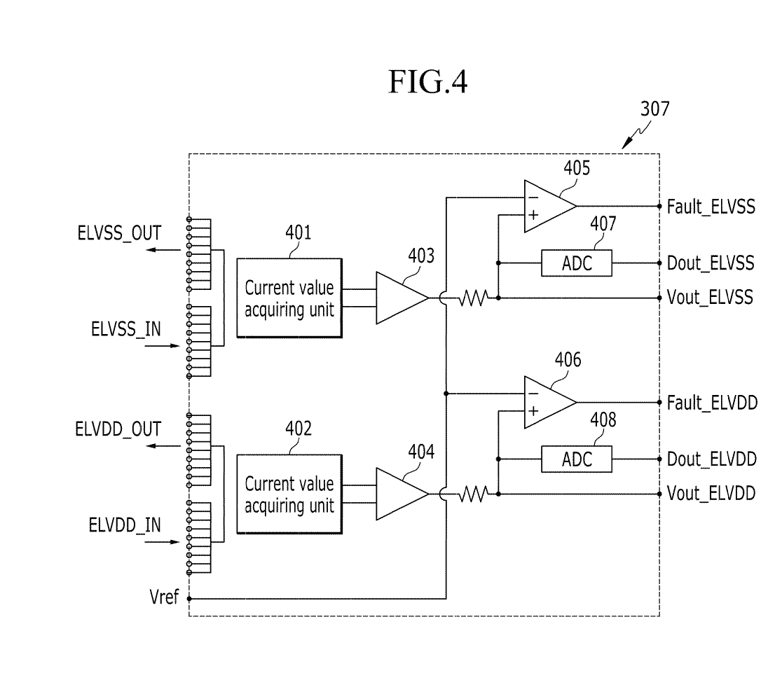

FIG. 4 is a circuit diagram illustrating a configuration of current sensor 307 in driving circuit 30 of FIG. 3 in further detail.

The current sensor 307 may include a plurality of current value acquiring units (measuring units) 401 and 402, a plurality of amplification units 403 and 404, a plurality of comparators 405 and 406, and a plurality of analog-to-digital converters (ADCs) 407 and 408.

The plurality of current value acquiring units include a first current value acquiring unit 402 provided for measuring the amount of current corresponding to the first power source voltage. The first current value acquiring unit 402 might be connected to the a first power source voltage input unit ELVDD_IN, to which the first power source voltage is input, and also a first power source output unit ELVDD_OUT, through which the first power source voltage is discharged. Also the first current value acquiring unit 402 might be provided adjacent the first power source voltage input unit ELVDD_IN and the first power source output unit ELVDD_OUT.

The plurality of current value acquiring units also include a second current value acquiring unit 401 provided for measuring the amount of current corresponding to the second power source voltage. The second current value acquiring unit 401 might be connected to a second power source voltage input unit ELVSS_IN, to which the second power source voltage is input, and also a second power source voltage out unit ELVSS_OUT, through which the second power source voltage is discharged. Also the second current value acquiring unit 402 might be provided adjacent the second power source voltage input unit ELVSS_IN and the second power source output unit ELVSS_OUT.

In the driving circuit 30, a method for detecting the amount of current used by the current value acquiring units 401 and 402 in the driving circuit 30 may include a typical sensing method, and is not limited to a specific method. That is, a current sensor applying a Hall effect may be provided, and a current sensor may be formed of a circuit using a current sensing resistor. The Hall effect, as understood by those of ordinary skill in the relevant art, is the generation of an electric potential perpendicular to both an electric current flowing along a conducting material and an external magnetic field applied at right angles to the current upon application of the magnetic field. A sensor that uses the Hall effect may be, for example, a transducer that varies its output voltage in response to a magnetic field.

The amount of current of the second power source voltage ELVSS, detected by the current value acquiring unit 401 may be transmitted to the comparator 405 through a resistor having a predetermined resistance, or information on the amount of current of the second power source voltage ELVSS may be directly output.

The amount of current of the first power source voltage ELVDD, detected by the current value acquiring unit 402 may be transmitted to the comparator 406 through a resistor having a predetermined resistance, or information on the amount of current of the first power source voltage ELVDD may be directly output.

The information on the amount of current of the second power source voltage ELVSS may be output by an analog second power source voltage output value Vout_ELVSS, or a digital second power source voltage output value Dout_ELVSS may be output through the ADC 407.

The information on the amount of current of the first power source voltage ELVDD may be output by an analog first power source voltage output value Vout_ELVDD, or a digital first power source voltage output value Dout_ELVDD may be output through the ADC 408.

A monitoring unit (not shown) is provided at an outer side of the driving circuit 30 to monitor the amount of supply current of a power voltage by acquiring information on an output voltage of each power voltage in real time. The monitoring unit monitors the amount of current of a power voltage in real time and turns off the driving system of the display device when a failure is suspected, to thereby protect the display device from a fire or smoke phenomenon.

As an another example embodiment, the information on the amount of current for the second power source voltage ELVSS is input to the comparator 405, and the information on the amount of current for the first power source voltage ELVDD is input to the comparator 406.

In further detail, information on the amount of current of a predetermined reference voltage Vref is input to an inverse input terminal (−) of the comparator 405, and information on the amount of current of the second power source voltage ELVSS is input to a non-inverse input terminal (+). In this case, the comparator 405 compares the information on the two current amounts input to the lateral input terminals thereof, and when the amount of current of the second power source voltage ELVSS is an excessive current that is higher than the value of the predetermined reference voltage Vref, a second power source voltage fault signal Fault_ELVSS is generated.

In addition, information on the amount of current of the predetermined reference voltage Vref is input to an inverse input terminal (−) of the comparator 406, and information on the amount of current of the first power source voltage ELVDD is input to an inverse input terminal (+) of the comparator 406. In this case, the comparator 406 compares the information on the two current amounts input to the lateral input terminals thereof, and when the amount of current of the first power source voltage ELVDD is an excessive current that is higher than the value of the predetermined reference voltage Vref, a first power source voltage fault signal Fault_ELVDD is generated.

The second power source voltage fault signal Fault_ELVSS or the first power source voltage fault signal Fault_ELVDD is a signal generated by detecting an overcurrent that occurs when a burn is generated in the display panel and thus an overcurrent flows due to concentration of a current into a specific portion.

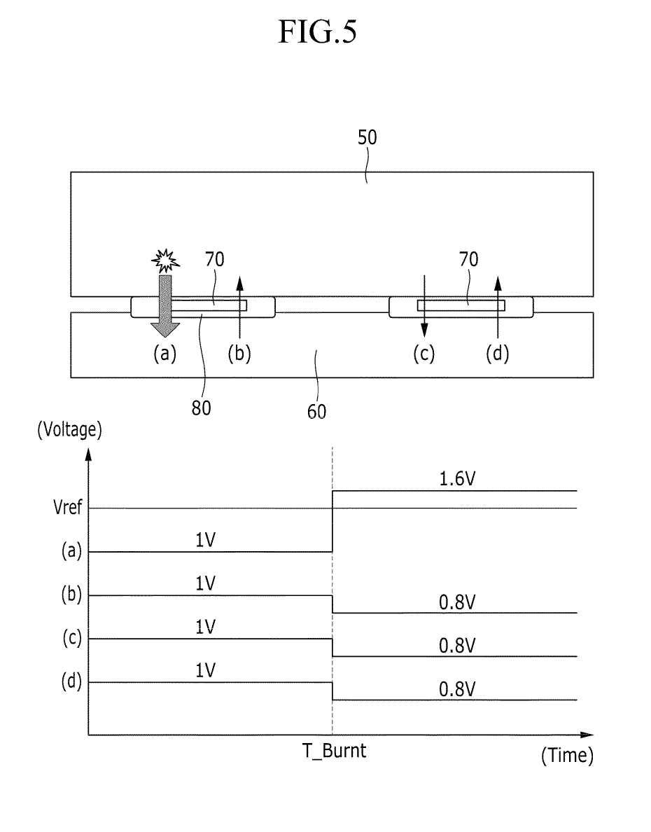

FIG. 5 shows a partial configuration of a display device where a burn has occurred and a graph of monitored voltages.

The variation of the current flowing in the driving power source voltage supply wire is detected in four locations of (a), (b), (c), and (d) over a period of time, as shown in FIG. 5. That is, the current sensor included in the driving circuit 70 detects the amount of current of the power source voltage in the locations (a), (b), (c), and (d). When a burn occurs in a location of the display panel 50, excessive current flows toward the base film 60 through a power supply wire arranged via the driving circuit 70, as indicated with like thick arrow shown at location (a) of the drawing. Viewing the graph in FIG. 5, for an undamaged display panel, the amount of current associated with 1V flows. After a time T_Burnt at which a burn occurs, an excessive current with an associated voltage of over 1.6V flows in the power supply line at the location (a).

In this case, the amount of current flowing at the locations (b), (c), and (d) relatively corresponds to a voltage of 0.8V.

Then, the current sensor of the driving circuit 70 generates and outputs the first power source voltage fault signal Fault_ELVDD or the second power source voltage fault signal Fault_ELVSS depending on whether the power supply wire at the location (a) transmits the first power source voltage or the second power source voltage. Also, the driving system or the power supply system of the display device may be turned off to protect the display device in response to the first power source voltage fault signal Fault_ELVDD or the second power source voltage fault signal Fault_ELVSS.

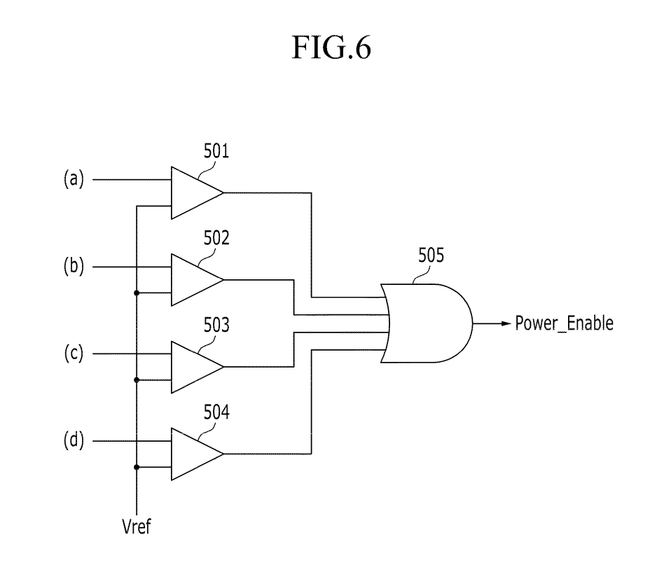

FIG. 6 is a circuit diagram of an external logic unit performing current detecting and monitoring, and according to an implementation, detecting that an excessive current corresponding to a voltage supplied at each location (e.g., (a), (b), (c), and (d)) of each power supply line in interaction with the fault signal.

FIG. 6 illustrates a logic unit provided at the external side of the driving circuit, and the logic unit is formed of comparators 501 to 504 respectively comparing the amount of current in power supply wires at the corresponding locations with the amount of current of the predetermined reference voltage Vref, and an operation unit 505 collecting output signals and performing operation on the collected signals. The logic unit of FIG. 6 is a single OR gate 505 performing an OR operation by connecting output signals at the wires of the respective locations, and when a fault signal is output due to an excessive current, as determined by the detected information on the amount of current in one power supply line, a power enable signal Power enable is output according to the operation result to control operation of the power system or the driving system of the display device.

Then, power supply is blocked in the power system or driving system of the display device upon receipt of the power enable signal Power enable, and accordingly, the display device can be protected from the burn.

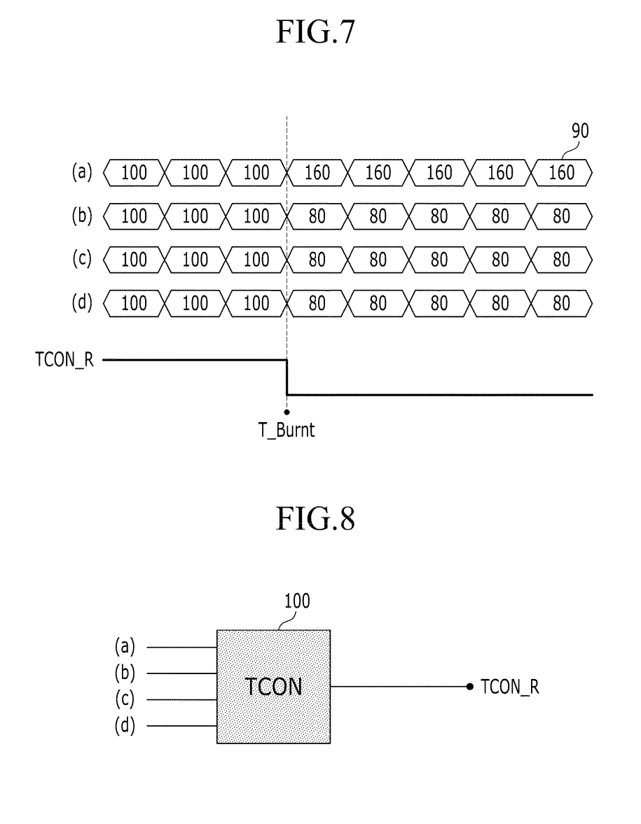

FIG. 7 shows a method for protecting the display device by using a digital output value output from the current sensor 307 of FIG. 4.

In further detail, the current sensor 307 generates a second power source output value Dout_ELVSS of a digital signal or a first power source voltage output value Dout_ELVDD of a digital signal, and a digital current amount output value varying at each location (e.g., location of (a), (b), (c), and (d)) after the occurrence of a burn is monitored in real time.

The second power source output value Dout_ELVSS of the digital signal or the first power source voltage output value Dout_ELVDD of the digital signal is transmitted as a digital value to a signal control that may be provided in the driving circuit or at an external side of the driving circuit.

In FIG. 7, as a digital signal, a value of 100 may indicated the voltage of 1V, a value of 160 may indicate a voltage of 1.6V, and a value of 80 may indicate a voltage of 0.8V.

As shown in FIG. 7, the current sensor 307 generates the second power source output value Dout_ELVSS of the digital signal or the first power source voltage output value Dout_ELVDD of the digital signal for each time unit, and the digital value is significantly increased to 160 at the location (a) after the time T_Burnt, at which a burn occurred. This implies that an excessive current abnormally flows to the current sensor in the driving circuit from the display panel. As described, a difference in the digital signal is detected, and when a digital value of the amount of current is higher than a predetermined threshold range, the signal controller may turn off the driving system of the entire display device by changing a control signal TCON_R.

FIG. 8 shows that the second power source output value Dout_ELVSS of the digital signal or the first power source voltage output value Dout_ELVDD of the digital signal, output for each power supply location (a), (b), (c) and (d), is collected in the signal controller 100. When a digital signal that is excessively changed (at the burn time T_Burnt) is received, the signal controller 100 changes the control signal TCON_R and outputs the changed control signal. That is, the signal controller 100 changes the signal output from the high-level control signal CONT_R that turns on the driving system of the display device to a low level to turn off operation of the entire display device.

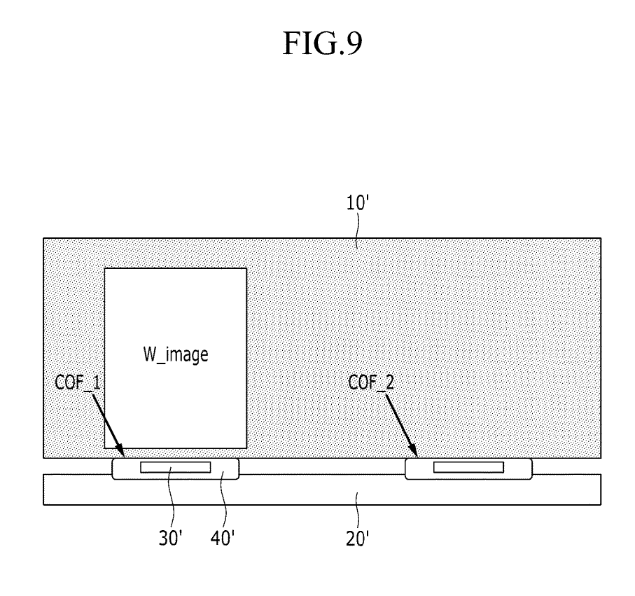

FIG. 9 schematically shows a structure of the display device in which a current concentration phenomenon occurs in a normal condition.

As an additional example embodiment, FIG. 9 shows a phenomenon in which a current is temporarily concentrated in a normal screen output. That is, as in the previously described example embodiments, the amount of current corresponding to a power voltage in a power supply wire in the current sensor of a driving circuit 30′ is monitored in real time, and when an excessive current flows, a fault signal is generated to turn off the entire system. However, the amount of current may be temporarily increased for realization of a screen that displays an input image data with luminance of a white screen or luminance similar to the white screen.

In the driving circuit provided, at a first bonding pad COF_{—}1 on the left side in a display panel 10′ of FIG. 9, the display screen is a white screen W_image, and therefore an excessive amount of current may be detected compared to the amount of current of a power source voltage detected in a driving circuit provided in a second bonding pad COF_{—}2.

However, the amount of current may be temporarily excessive in displaying a normal screen based on an image signal, and therefore, a configuration is required that is capable of determining whether the excessive amount of current detected by the current sensor of the driving circuit is caused by normal image realization or caused by current concentration due to a failure.

Therefore, in the example embodiment of FIG. 9, the signal controller provided in the driving circuit 30′ or provided in the external side of the driving circuit 30′ primarily analyzes input image data to determine if current concentration may occur due to application of an image signal of luminance that is higher than a predetermined luminance.

In FIG. 9, an image data signal of a white screen W_image is transmitted to the signal controller, and the signal controller sets an expected normal amount of current with respect to the white screen W_image and transmits information on the expected normal amount of current to the current sensor of the driving circuit 30′, that is, the current sensor of the driving circuit provided in the first bonding pad COF_{—}1. Then, the current sensor compares the expected amount of current and the amount of current transmitted through a power supply wire measured at a location corresponding to the white screen W_image in real time, to determine whether the excessive current occurred during a normal driving or occurred due to abnormal current concentration.

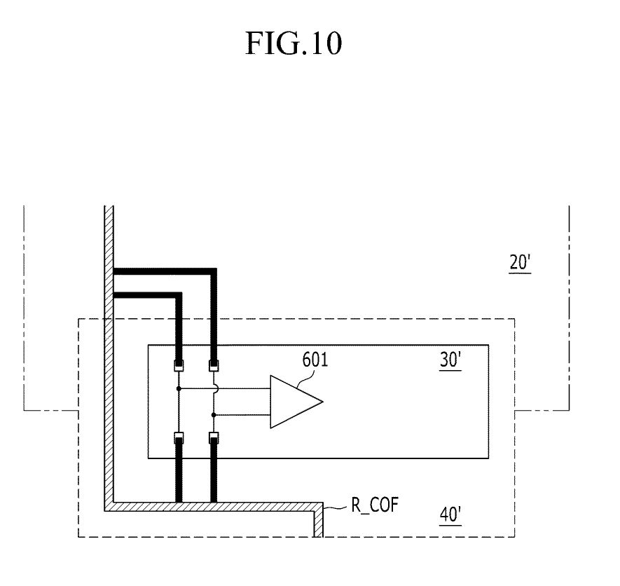

FIG. 10 schematically shows a current sensing method using root resistance of a base film and a bonding pad in a chip on film (COF) configuration.

In the example embodiment of FIG. 10, a driving circuit 30′ measuring the amount of current of a driving power voltage of a power supply wire may use resistance (referred to as root resistance) that depends on resistance of a bonding pad 40′ and a base film (20′). That is, power supply wires transmit driving power voltages, i.e., a first power source voltage ELVDD and a second power source voltage ELVSS that pass through the bonding pad 40′ and the base film 20′. The amount of current can be measured while minimizing a loss of the power source voltages by detecting the amount of current using resistance in a COF path.

In this case, in FIG. 10, the structure of the current sensor provided in the driving circuit 30′ is simplified to a structure of the comparator 601, but the above-described current sensor is included, and therefore no further description will be provided.

While this disclosure describes what is presently considered to be practical example embodiments, it is to be understood that the invention is not limited to the disclosed embodiments, but, on the contrary, is intended to cover various modifications and equivalent. Therefore, those skilled in the relevant art can easily select and substitute the drawings and disclosed description. Those skilled in the relevant art can omit some of the constituent elements described in the present specification without deterioration in performance thereof or can add constituent elements to improve performance thereof. Furthermore, those skilled in the art can modify a sequence of the steps of the method described depending on the process environment or equipment.

<Description of symbols>

| | |
|---|---|
| 10, 10′, 50: display panel | 20, 20′, 60: base film |
| 30, 30′, 70: driving circuit | 40, 40′, 80: bonding pad |

What is claimed is:

1. A display device comprising:
a display panel including a plurality of pixels, the plurality of pixels configured to display an image based on an image data signal, and a film package including at least one driving circuit,
wherein the film package includes a base film integrated with the at least one driving circuit and a bonding pad connecting each of the driving circuits between the display panel and the base film, and
wherein the at least one driving circuit includes a current sensor detecting an amount of current corresponding to a driving power source from at least one wire of a plurality of supply wires of driving power voltages, the supply wires passing through the film package in the display panel.

2. The display device of claim 1, wherein the driving power voltage comprises a predetermined high-level first power source voltage and a predetermined low-level or ground-potential second power source voltage.

3. The display device of claim 1, wherein the current sensor comprises:
at least one measuring unit configured to measure an amount of current and connected to an input unit and an output unit of the driving power voltage to measure the amount of current corresponding to the driving power voltage;
at least one amplification unit and a resistor adjusting the amount of current measured by the measuring unit;
a first output terminal outputting information on the controlled amount of current;
a second output terminal converting the information on the controlled amount of current and outputting as a digital information value; and
a third output terminal comparing the controlled amount of current with a predetermined reference voltage and outputting a fault signal when the controlled amount of current is excessive compared to the amount of current of the reference voltage.

4. The display device of claim 3, wherein the measuring unit is a current sensor using a Hall effect or a current sensor using resistance in a path through which the driving power voltage is transmitted.

5. The display device of claim 3, further comprising a monitoring unit monitoring information on the amount of current output from the first output terminal or the second output terminal.

6. The display device of claim 3, further comprising a signal controller receiving the current amount information output from the first output terminal or the second output terminal, and generating and transmitting a control signal that turns off a power system or a driving system of the display device when the amount of current exceeds a predetermined current amount.

7. The display device of claim 6, wherein the signal controller receives the image data signal, acquires information on an expected amount of current corresponding to luminance of the image data signal, and transmits the information on the expected amount of current to the current sensor of the driving circuit, and the current sensor compares a measured current amount with the expected current amount.

8. The display device of claim 3, further comprising a logic unit acquiring information on a comparison result output from the third output terminal and performing an operation,
wherein the logic unit outputs an enable signal that controls operation of a driving system of the display device corresponding to a fault signal generated based on the comparison result.

9. A method for protecting a display device, the display device including a display panel including a plurality of pixels configured to display an image based on an image data signal, at least one driving circuit, and a film package including the at least one driving circuit, the method comprising:
detecting the amount of current corresponding to a driving power voltage passing through the film package in the display panel from at least one of a plurality of supply wires;
controlling the detected amount of current and outputting the controlled amount of current as at least one of analog information, digital information, and a fault signal, wherein the faulting signal is set by comparing the controlled amount of current with a predetermined reference voltage, and outputting the fault signal corresponding to a comparison result when the detected amount of current is excessive compared to an amount of current corresponding to the predetermined reference voltage; and
monitoring the analog information or digital information and turning off a power system or driving system of the display device when the amount of current is excessive compared to a predetermined current amount or when the fault signal is transmitted.

10. The method for protecting the display device of claim 9, wherein the display device further includes a signal controller,
the method for protecting the display device further comprising receiving the analog information or digital information, comparing the received information with a predetermined current amount, and generating a control signal that turns off the power system or driving system of the display device when the amount of current exceeds the predetermined current amount.

11. The method for protecting the display device of claim 9, wherein the display device further includes a signal controller, and
the signal controller acquires information on an expected amount of current corresponding to luminance of the image data signal by receiving the input data signal, and transmits information on the expected amount of current to the driving circuit.

12. The method for protecting the display device of claim 9, wherein the display device further includes a logic unit acquiring information on the comparison result and performing an operation, and
the logic unit outputs an enable signal that controls operation of the driving system of the display device corresponding to the fault signal generated according to the comparison result.
